(19) United States
(12) Patent Application Publication
(10) Pub. No.: US 2026/0025046 A1
(43) Pub. Date: Jan. 22, 2026

(54) OIL-COOLED DRIVE MOTOR INCLUDING REPLACEABLE OIL FILTER

(71) Applicant: HYUNDAI MOBIS CO., LTD., Seoul (KR)

(72) Inventors: Dae Wook KIM, Yongin-si (KR); Myung Jun GAM, Yongin-si (KR)

(73) Assignee: HYUNDAI MOBIS CO., LTD., Seoul (KR)

(21) Appl. No.: 19/232,176

(22) Filed: Jun. 9, 2025

(30) Foreign Application Priority Data
Jul. 17, 2024 (KR) 10-2024-0094680
Oct. 4, 2024 (KR) 10-2024-0134737

(51) Int. Cl. H02K 9/26; H02K 9/19

(52) U.S. Cl. CPC H02K 9/26; H02K 9/19

(57) ABSTRACT

The objective of the present disclosure is to provide an oil-cooled drive motor including a replaceable oil filter equipped with an opening/closing device on the oil flow path to prevent oil leakage during oil filter replacement. More specifically, the disclosure provides an oil-cooled drive motor including a replaceable oil filter equipped with an inlet opening/closing device capable of sealing the oil inlet for supplying oil to the oil filter space during oil filter replacement, and an outlet opening/closing device capable of blocking the oil flow path through which filtered oil flows. Particularly, the disclosure provides an oil-cooled drive motor including a replaceable oil filter wherein the inlet opening/closing device and the outlet opening/closing device are configured to open or block the oil inlet and the oil flow path in conjunction with the rotation of the oil filter during replacement.

### CROSS REFERENCE TO RELATED APPLICATION

The present application claims priority to Korean Patent Application Nos. 10-2024-0094680, filed Jul. 17, 2024, and 10-2024-0134737, filed Oct. 4, 2024, the entire contents of which are incorporated herein for all purposes by this reference.

### BACKGROUND OF THE DISCLOSURE

### Field of the Disclosure

The present disclosure relates to a liquid-cooled drive motor including a replaceable oil filter, and more particularly, to a liquid-cooled drive motor including a replaceable oil filter provided with an opening/closing device on the oil flow path to prevent oil leakage from the filter housing during oil filter replacement.

### Description of the Related Art

A hybrid vehicle operates in an electric vehicle (EV) mode using only the power of the drive motor or in a hybrid electric vehicle (HEV) mode using the rotational forces of both the engine and the drive motor. The drive motor, used as a power source for the vehicle, includes a stator core and a rotor core, with the stator core coupled within the motor housing and the rotor core disposed inside the stator core.

A refrigerant flow path is formed on the housing to cool the heat generated by the stator core and rotor core during motor operation, and refrigerant flows through the flow path to cool the stator core and rotor core.

As such, directly cooling the motor's interior with oil allows foreign substances, such as chips generated in the reducer, to move with the oil, which can cause issues in motor operation if not removed.

Thus, an oil filter is placed in the cooling flow path where oil moves to filter chips and foreign substances along with the oil. Recently, oil filters are configured as replaceable, allowing the removal of the installed oil filter after a certain period and the installation of a new oil filter to enhance foreign substance removal efficiency.

Conventional drive motors including replaceable oil filters require complete oil drainage before filter replacement due to oil leakage during filter removal, followed by the cumbersome process of refilling oil after replacement.

Therefore, there is a need to develop a technology to block the oil flow path during oil filter replacement to prevent oil leakage.

### SUMMARY OF THE DISCLOSURE

The present disclosure has been conceived to address the above issue, and an object of the disclosure is to provide an oil-cooled drive motor including a replaceable oil filter equipped with an opening/closing device on the oil flow path to prevent oil leakage during oil filter replacement.

It is another object of the present disclosure to provide an oil-cooled drive motor including a replaceable oil filter equipped with an inlet opening/closing device capable of sealing the oil inlet that supplies oil to the oil filter space during oil filter replacement, and an outlet opening/closing device capable of blocking the upstream side of the oil flow path where filtered oil is supplied.

It is still another object of the present disclosure to provide an oil-cooled drive motor including a replaceable oil filter, wherein the inlet opening/closing device and the outlet opening/closing device are interlocked with the rotation of the oil filter during replacement to open or block the oil inlet and oil flow path.

An oil-cooled drive motor according to an embodiment of the present disclosure includes a housing accommodating components therein, having an oil flow path through which refrigerant flows to cool the components, a filter housing formed on the housing, and a replaceable oil filter coupled replaceably with the filter housing for filtering foreign substances in the refrigerant, wherein the filter housing includes a filter insertion space configured to fixedly accommodate the oil filter, an oil inlet configured to communicate the filter insertion space with a discharge side of the oil flow path to supply oil to the filter insertion space, an oil discharge pipe configured to communicate with an inlet side of the oil flow path to return oil filtered through the oil filter to the oil flow path, protruding toward the filter insertion space, and an opening/closing door provided on an inner surface of the filter insertion space, configured to seal the oil inlet by moving to one side in a circumferential direction and open the oil inlet by moving to the other side in the circumferential direction.

In addition, the oil filter is configured to be inserted into the filter insertion space along an axial direction and then constrained or released by rotation, and includes a cylindrical filter body configured to filter oil supplied to the filter insertion space while the oil moves radially inward to a hollow portion of the filter body, the filter body including a first-first driving protrusion formed on one side in the circumferential direction and a first-second driving protrusion spaced on the other side, both formed around an axial outer circumference of the filter body and protruding radially outward, and, upon insertion of the replaceable oil filter into the filter insertion space, the first-first driving protrusion and the first-second driving protrusion being configured to fit circumferential ends of the opening/closing door therebetween, causing the opening/closing door to reciprocate in the circumferential direction in conjunction with the rotation of the replaceable oil filter during constraint or release.

In addition, the opening/closing door is configured to open the oil inlet upon constraint of the replaceable oil filter and seal the oil inlet upon release of the replaceable oil filter, wherein the replaceable oil filter is constrained in the filter insertion space by rotation to one side in the circumferential direction and released from the filter insertion space by rotation to the other side in the circumferential direction.

In addition, the inner surface of the filter insertion space a first rail groove recessed radially outward along the circumferential direction, configured to guide the circumferential movement of the first-first and first-second driving protrusions, and a second rail groove recessed radially outward along the axial direction, configured to guide the axial movement of the first-first and first-second driving protrusions.

In addition the opening/closing door is formed as a plate with an arc-shaped cross-section configured to slide along the inner surface of the filter insertion space, and includes a first rail protrusion on the outer circumferential surface of the opening/closing door, formed along the circumferential direction and protruding radially outward to be inserted into the first rail groove.

In addition, the first-first and first-second driving protrusions are formed on the axial outer side of the filter body, and a second-first and second-second driving protrusion are formed at a certain distance inward in the axial direction from the first-first and first-second driving protrusions of the filter body.

In addition, the filter insertion space includes a stopper protruding radially inward, configured to abut a circumferential end on one side of the opening/closing door to prevent further movement in one circumferential direction upon the opening/closing door sealing the oil inlet.

In addition, the drive motor further includes an outlet opening/closing device configured to open or block an upstream side of the oil flow path through which oil discharged from the replaceable oil filter flows.

In addition, the housing includes a slide groove formed orthogonal to the oil flow path and configured to allow the outlet opening/closing device to be inserted and moved therein, the outlet opening/closing device being configured to open the oil flow path by sliding to one side and block the oil flow path by sliding to the other side.

In addition, the slide groove is formed adjacent to the filter housing, with an elastic member provided between one end of the outlet opening/closing device and one end of the slide groove, the outlet opening/closing device being configured to be pressed by the replaceable oil filter during axial inward movement to open the oil flow path by sliding inward, and to slide to the other side in the axial direction by the elasticity of the elastic member during axial outward movement of the replaceable oil filter to close the oil flow path.

In addition, the oil-cooled drive motor further include an outlet opening/closing device configured to open or close the inlet side of the oil discharge pipe.

In addition, the oil-cooled drive motor further includes an outlet opening/closing device provided at an end of the oil discharge pipe, configured to open or close the oil discharge pipe, the outlet opening/closing device including a rubber sealing portion configured to close the oil discharge pipe under normal conditions and open upon pressurization, and the replaceable oil filter further including a pressing protrusion configured to press the outlet opening/closing device during axial inward movement for installation and release the pressure on the outlet opening/closing device during axial outward movement for removal.

### BRIEF DESCRIPTION OF THE DRAWINGS

FIG. 1 is a cross-sectional perspective view illustrating an oil filter housing and oil flow path of a drive motor coupled with an oil filter according to the first embodiment of the present disclosure;

FIG. 2A and FIG. 2B are cross-sectional perspective views illustrating the opening or blocking of an oil flow path using an outlet opening/closing device according to the first embodiment of the present disclosure;

FIG. 3 is a cross-sectional perspective view illustrating an oil filter housing, oil flow path, and inlet opening/closing device of a drive motor coupled with an oil filter according to an embodiment of the present disclosure;

FIG. 4 is a cross-sectional perspective view illustrating an oil filter housing according to an embodiment of the present disclosure;

FIG. 5A and FIG. 5B are front and rear perspective views of an opening/closing door according to an embodiment of the present disclosure;

FIG. 6 is a cross-sectional perspective view illustrating an oil filter housing coupled with an opening/closing door according to an embodiment of the present disclosure;

FIG. 7 is a cross-sectional perspective view illustrating an oil filter housing with an oil inlet sealed by an opening/closing door according to an embodiment of the present disclosure;

FIG. 8 is a perspective view of an oil filter including an inlet opening/closing device according to an embodiment of the present disclosure;

FIG. 9 is an exploded cross-sectional perspective view of an oil filter housing and an oil filter including an outlet opening/closing device according to the second embodiment of the present disclosure;

FIG. 10 and FIG. 11 are cross-sectional perspective views illustrating the opening or blocking of an oil flow path using an outlet opening/closing device according to the second embodiment of the present disclosure;

FIG. 12 is a perspective view of an outlet opening/closing device according to the second embodiment of the present disclosure;

FIG. 13 is a perspective view of an oil filter according to the second embodiment of the present disclosure;

FIG. 14 is an enlarged cross-sectional perspective view illustrating the drive mechanism of an outlet opening/closing device and an oil filter according to the second embodiment of the present disclosure;

FIG. 15 is a cross-sectional perspective view of an oil filter housing including an outlet opening/closing device according to the third embodiment of the present disclosure;

FIG. 16 is a cross-sectional perspective view of an oil filter according to the third embodiment of the present disclosure; and

FIG. 17 is a cross-sectional perspective view illustrating the opening/closing mechanism of an outlet opening/closing device due to the coupling of an oil filter housing and an oil filter according to the third embodiment of the present disclosure.

### DETAILED DESCRIPTION OF THE DISCLOSURE

Hereinafter, an embodiment of the present disclosure will be described in detail with reference to the drawings.

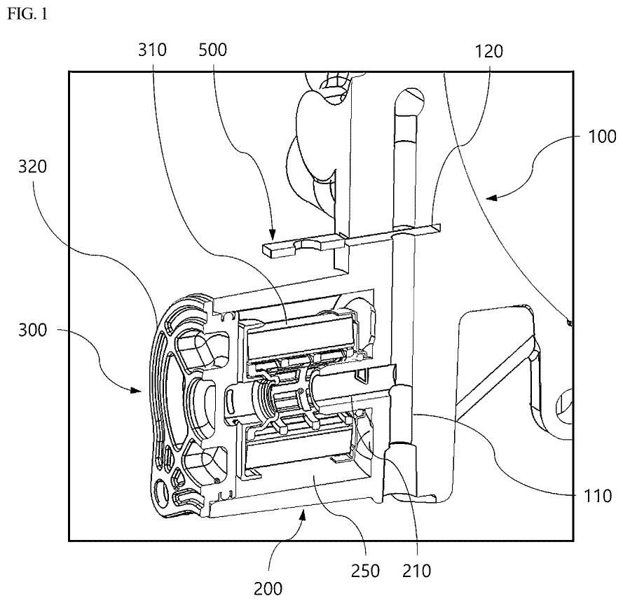

FIG. 1 is a cross-sectional perspective view illustrating an oil filter housing 200 and an oil flow path 110 on a housing 100 of a drive motor coupled with an oil filter 300 according to an embodiment of the present disclosure.

As illustrated, the oil-cooled drive motor 1000 according to an embodiment of the present disclosure includes a housing 100 accommodating a stator and a rotor of the drive motor, a filter housing 200 integrally formed with the housing 100 and accommodating an oil filter 300, and an outlet opening/closing device 500 for opening or closing the oil flow path 110 to recover oil filtered by the oil filter 300.

The housing 100 has an oil flow path 110 through which refrigerant flows for cooling the components, and a filter housing 200 for coupling the oil filter 300 may be integrally formed with the housing 100. Additionally, the housing 100 has a slide groove 120 into which the outlet opening/closing device 500 is inserted and moved, formed orthogonal to the oil flow path 110, for opening or blocking the oil flow path 110 through which oil flows after passing through the oil filter 300.

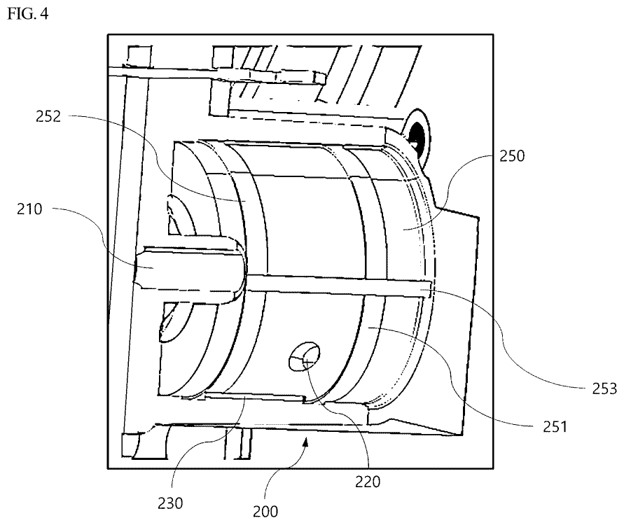

The filter housing 200 is cylindrical with a filter insertion space 250 formed inside, with an inner end sealed by the housing 100 and an outer end open. At the inner end of the filter housing 200, an oil discharge pipe 210 may protrude outward at the center, with the upstream side of the oil discharge pipe 210 connected to the inlet side of the oil flow path 110 to supply filtered oil from the oil filter 300 to the oil flow path 110. Additionally, the filter housing 200 has an oil inlet 220 (see FIG. 4) for introducing oil into the oil filter 300, and the oil inlet 220 may be connected to the discharge side formed at the end of the oil flow path 110.

The oil filter 300 includes a cylindrical filter body 310 and a filter cap 320 provided at the outer end of the filter body 310 to seal the open side of the filter housing 200 and fix the filter body 310 to the filter housing 200. The filter body 310 and the filter cap 320 may be integrally formed as in this embodiment or may be separately formed. The filter body 310 may be a hollow cylinder along its longitudinal direction, with the oil discharge pipe 210 penetrating the inner end of the hollow portion to discharge oil from the hollow portion to the oil flow path 110 through the oil discharge pipe 210. Thus, oil introduced into the filter housing 200 through the oil inlet 220 is filtered through the filter body 310, flows into the radially inner hollow portion of the filter body 310, and is returned to the inlet side of the oil flow path 110 through the oil discharge pipe 210.

Here, the housing 100 may include an outlet opening/closing device 500 to block the upstream side of the oil flow path 110, preventing oil stored in the oil flow path 110 from flowing back through the oil discharge pipe 210 during oil filter 300 replacement. The outlet opening/closing device 500 is a plate with a predetermined length, inserted into the slide groove 120, and configured to slide to open or block the oil flow path 110.

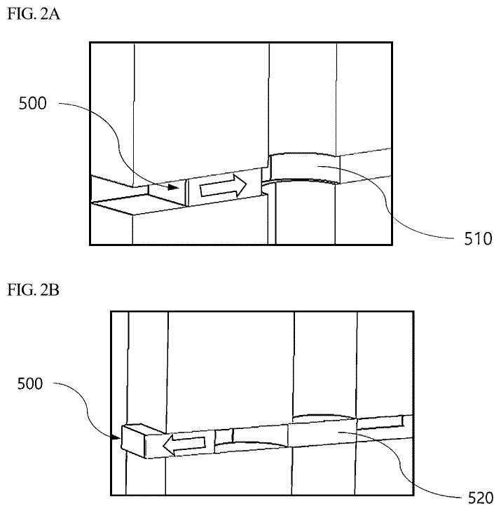

FIG. 2A and FIG. 2B is a cross-sectional perspective view illustrating the opening or blocking of the oil flow path 110 using the outlet opening/closing device 500 of the present disclosure.

As illustrated, the outlet opening/closing device 500 may have an open surface 510 and a closed surface 520 sequentially formed along its longitudinal direction. Thus, when the open surface 510 is positioned over the oil flow path 110 by sliding the outlet opening/closing device 500 to one side, as shown in FIG. 2A, the oil flow path 110 is opened, allowing oil to flow; when the closed surface 520 is positioned over the oil flow path 110 by sliding to the other side, the oil flow path 110 is blocked, stopping oil flow.

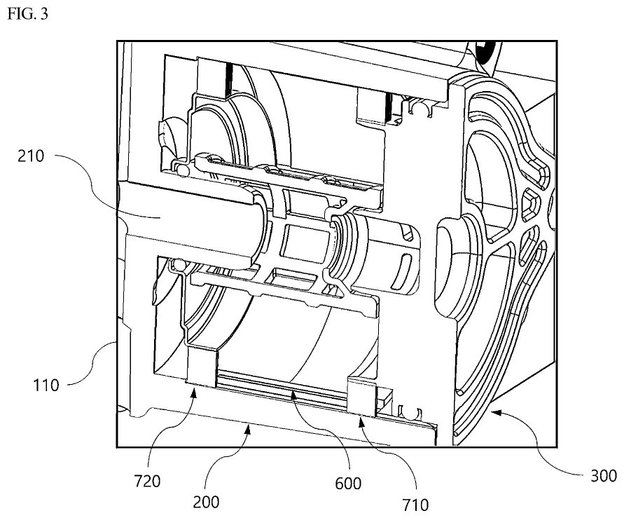

FIG. 3 is a cross-sectional perspective view illustrating an oil filter housing 200, an oil flow path 110, and an inlet opening/closing device 600, 710, and 720 of a drive motor coupled with an oil filter 300 according to an embodiment of the present disclosure.

As illustrated, the drive motor further includes an inlet opening/closing device 600, 710, and 720 for opening or closing the oil inlet 220 (see FIG. 4) formed on the filter housing 200. The inlet opening/closing device includes an opening/closing door 600 provided on the inner circumferential surface of the filter insertion space 250 and reciprocating in a circumferential direction, and first and second driving protrusions 710 and 720 provided on the filter body 310 to slide the opening/closing door 600 circumferentially during axial rotation of the oil filter 300 for replacement.

The oil filter 300 is inserted axially into the filter housing 200 and rotated circumferentially by a certain angle to be fixed to the filter housing 200 for secure coupling during installation. During removal, the oil filter 200 is rotated in the opposite direction by a certain angle to release the fixation and then moved axially to separate it from the filter housing 200. Thus, by providing the first and second driving protrusions 710 and 720 on the filter body 310 to move the opening/closing door 600, the opening/closing door 600 slides circumferentially by a certain angle in conjunction with the rotation of the oil filter 300, opening or sealing the oil inlet 220.

The inlet opening/closing device 600, 710, and 720 according to an embodiment of the present disclosure with the above configuration is described in more detail with reference to the drawings.

FIG. 4 is a cross-sectional perspective view illustrating the inner surface of the filter insertion space 250 of an oil filter housing 200 according to an embodiment of the present disclosure.

As illustrated, the inner surface of the filter insertion space 250 has an oil inlet 220 communicating with the downstream side of the oil flow path 110 to supply oil into the filter insertion space 250. Additionally, at the inner center of the filter insertion space 250, an oil discharge pipe 210 communicating with the upstream side of the oil flow path 110 to supply filtered oil to the oil flow path 110 may protrude toward the filter insertion space 250. Here, the inner surface of the filter insertion space 250 may have first rail grooves 251 and 252 formed to guide the sliding movement of the opening/closing door 600 and the circumferential movement of the first and second driving protrusions 710 and 720. The first rail grooves 251 and 252 are formed along the circumferential direction, consisting of a first-first rail groove 251 formed on the outer side and a first-second rail groove 252 spaced inward from the first-first rail groove 251. The first rail grooves 251 and 252 may be recessed radially outward from the inner surface of the filter insertion space 250.

Additionally, the inner surface of the filter insertion space 250 may have a second rail groove 253 formed to guide the axial movement of the first and second driving protrusions 710 and 720. The second rail groove 253 is formed along the axial direction and may be recessed radially outward from the inner surface of the filter insertion space 250.

The oil inlet 220 may be formed between the first-first rail groove 251 and the first-second rail groove 252.

Furthermore, when the opening/closing door 600 seals the oil inlet 220 by moving to one side and opens it by moving to the other side, a stopper 230 may be formed at a position corresponding to the circumferential end of the opening/closing door 600 to prevent further movement in the sealed state. The stopper 230 protrudes radially inward from the inner surface of the filter insertion space 250 and may be formed along the axial direction.

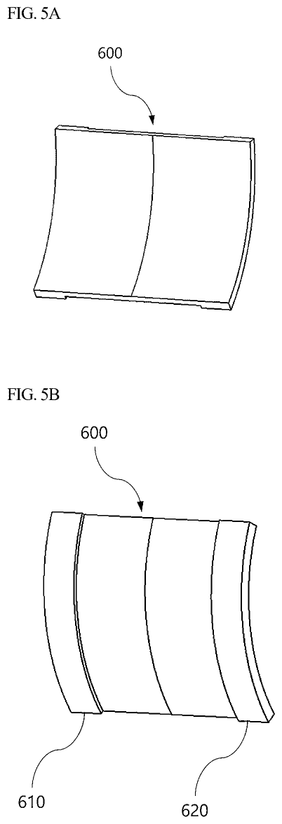

FIG. 5A and FIG. 5B are front and rear perspective views of the opening/closing door 600 of the present disclosure.

As illustrated, the opening/closing door 600 may be a plate with an arc-shaped cross-section to slide along the inner surface of the filter insertion space 250. Additionally, a first rail protrusion 610 may be formed on the outer side in the longitudinal direction of the outer circumferential surface of the opening/closing door 600, and a second rail protrusion 620 may be formed on the inner side. The first and second rail protrusions 610, 620 protrude radially outward, and when the opening/closing door 600 is seated on the inner surface of the filter insertion space 250, the first rail protrusion 610 is inserted into the first-first rail groove 251, and the second rail protrusion 620 is inserted into the first-second rail groove 252. Thus, the opening/closing door 600 is configured to move smoothly along the circumferential direction.

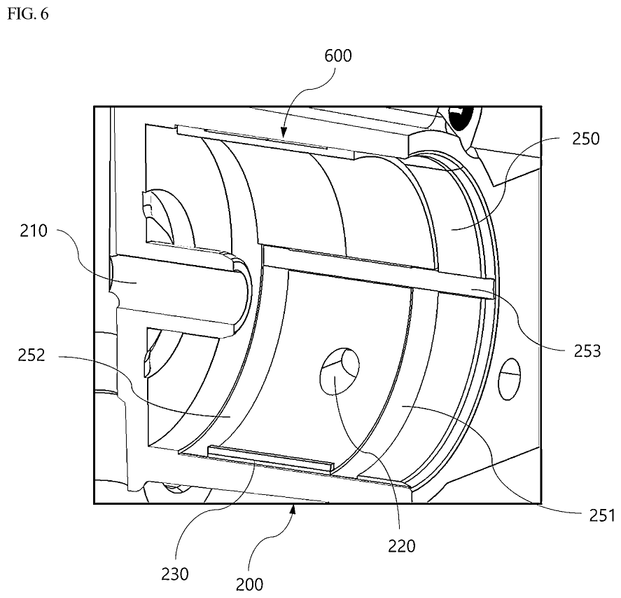

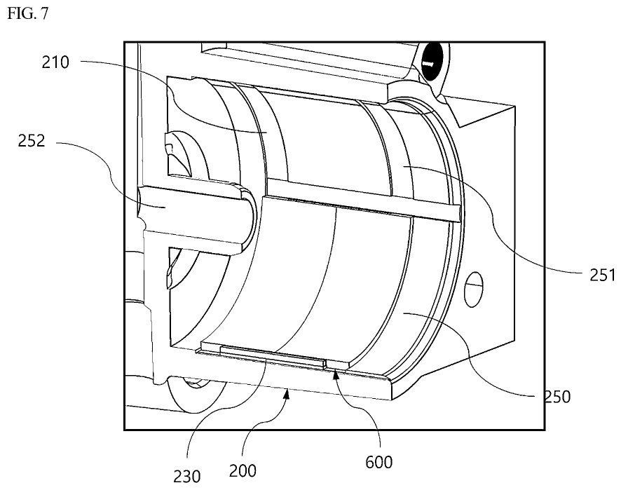

FIG. 6 is a cross-sectional perspective view illustrating an oil filter housing coupled with an opening/closing door 600 according to an embodiment of the present disclosure, and FIG. 7 is a cross-sectional perspective view illustrating an oil filter housing 200 with the oil inlet 220 sealed by the opening/closing door 600 according to an embodiment of the present disclosure.

As illustrated, the opening/closing door 600 is coupled to the inner surface of the filter insertion space 250 to slide along the circumferential direction. Here, the axial outer end of the opening/closing door 600 has the first rail protrusion 610 inserted into the first-first rail groove 251 for circumferential sliding, and the second rail protrusion 620 inserted into the first-second rail groove 252 for circumferential sliding.

Additionally, as shown in FIG. 6, the oil inlet 220 is opened when moving to the other side in the circumferential direction, and as shown in FIG. 7, the oil inlet 220 is sealed when moving to one side in the circumferential direction. Furthermore, the opening/closing door 600 is configured by the stopper 230 to prevent detachment in one direction while sealing the oil inlet 220.

Here, one side in the circumferential direction may be the release rotation direction of the oil filter, and the other side in the circumferential direction may be the locking rotation direction of the oil filter. Thus, when the oil filter is rotated to one side in the circumferential direction for removal, the opening/closing door 600 moves in conjunction to one side in the circumferential direction, sealing the oil inlet 220 to prevent oil in the oil flow path 110 from leaking through the oil inlet 220; when the oil filter is rotated to the other side in the circumferential direction for installation, the opening/closing door 600 moves in conjunction to the other side in the circumferential direction, opening the oil inlet 220 to allow oil in the oil flow path 110 to be supplied to the filter insertion space 250.

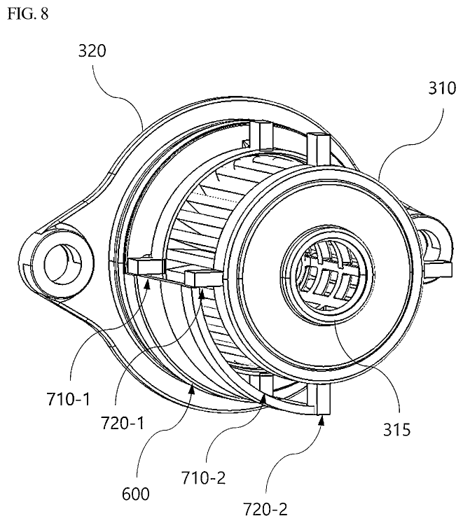

FIG. 8 is a perspective view illustrating an oil filter 300 including an inlet opening/closing device 710 and 720 according to an embodiment of the present disclosure.

As illustrated, the filter body 310 of the oil filter 300 includes first and second driving protrusions 710 and 720 to move the opening/closing door 600 in conjunction with the rotation of the oil filter 300.

The first driving protrusion 710 is formed around the axial outer circumference of the filter body 310 and may protrude radially outward. The first driving protrusion 710 includes a first-first driving protrusion 710-1 formed on one side in the circumferential direction and a first-second driving protrusion 710-2 spaced on the other side. The first driving protrusion 710 is inserted into and moves along the second rail groove 253 during axial movement for oil filter 300 installation, and upon completion of axial movement, the circumferential ends of the opening/closing door 600 are fitted between the first-first driving protrusion 710-1 and the first-second driving protrusion 710-2.

Thus, during rotation of the oil filter 300, the opening/closing door 600 fitted between the first-first driving protrusion 710-1 and the first-second driving protrusion 710-2 slides circumferentially in conjunction. The first driving protrusion 710 may be configured to slide within the first-first rail groove 251 during rotation of the oil filter 300.

The second driving protrusion 720 is formed around the axial inner circumference of the filter body 310 and may protrude radially outward. The second driving protrusion 720 includes a second-first driving protrusion 720-1 formed on one side in the circumferential direction and a second-second driving protrusion 720-2 spaced on the other side. The second driving protrusion 720 is inserted into and moves along the second rail groove 253 during axial movement for oil filter 300 installation, and upon completion of axial movement, the circumferential ends of the opening/closing door 600 are fitted between the second-first driving protrusion 720-1 and the second-second driving protrusion 720-2.

Thus, during rotation of the oil filter 300, the opening/closing door 600 fitted between the second-first driving protrusion 720-1 and the second-second driving protrusion 720-2 slides circumferentially in conjunction. The second driving protrusion 720 may be configured to slide within the first-second rail groove 252 during rotation of the oil filter 300.

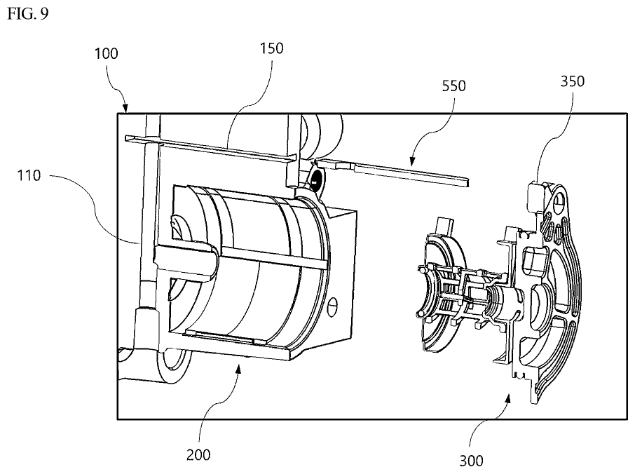

FIG. 9 is an exploded cross-sectional perspective view illustrating an oil filter housing 200 and an oil filter 300 including an outlet opening/closing device 550 according to a second embodiment of the present disclosure.

As illustrated, the housing 100 of the oil-cooled drive motor according to the second embodiment of the present disclosure includes a filter housing 200 integrally formed with the housing 100 and accommodating an oil filter 300, an oil filter 300 replaceably coupled to the filter housing 200, and an outlet opening/closing device 550 for opening or blocking the upstream side of the oil flow path 110 through which oil filtered by the oil filter 300 flows. Since the detailed configuration of the housing 100 is similar to that of the first embodiment described above, only the differences are explained in detail.

The housing 100 has a slide groove 150 into which the outlet opening/closing device 550 is inserted and moved, formed orthogonal to the oil flow path 110 for opening or blocking the oil flow path 110.

At this time, the slide groove 150 may be disposed adjacent to the filter housing 200. Thus, the oil flow path 110 is opened by pressing the outlet opening/closing device 550 with the oil filter 300 during oil filter 300 installation, and the oil flow path 110 is closed by moving the outlet opening/closing device 550 in the opposite direction of the pressing direction due to elastic restoration during oil filter 300 removal. That is, the outlet opening/closing device 550 slides in conjunction with the installation or removal of the oil filter 300, enabling the oil flow path 110 to open or close during installation or removal of the oil filter 300 without separate manipulation or a driving device.

For this purpose, an opening/closing device pressing portion 350 contacting the outlet opening/closing device 550 may be formed on the outer bottom surface of the oil filter 300 on the outer side in the circumferential direction. More specifically, the pressing portion 350 protrudes radially outward from the outer bottom surface and may be formed with a certain thickness inward in the axial direction.

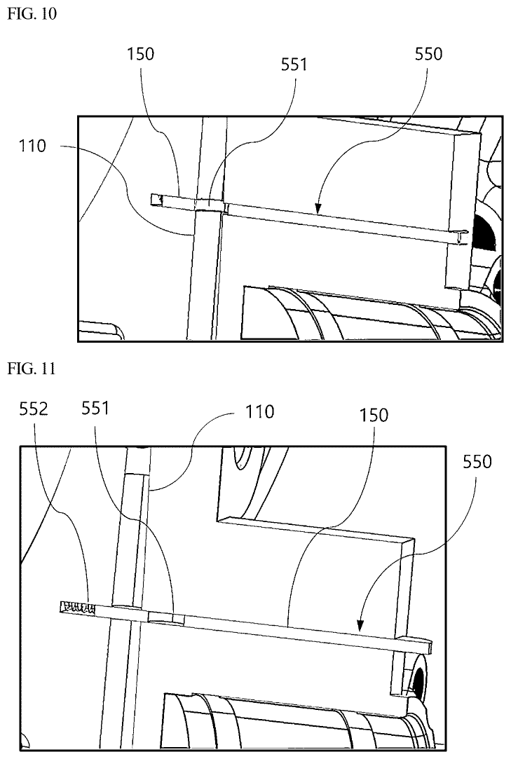

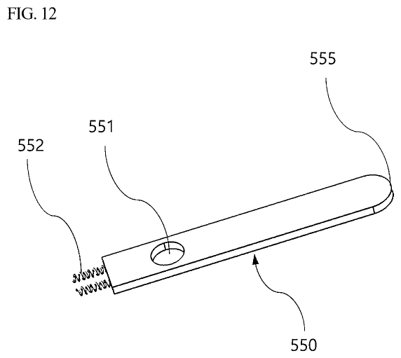

FIG. 10 and FIG. 11 are cross-sectional perspective views illustrating the opening or blocking of the oil flow path 110 using the outlet opening/closing device 550 according to the second embodiment of the present disclosure. Additionally, FIG. 12 is a perspective view illustrating the outlet opening/closing device 550 according to the second embodiment of the present disclosure.

As illustrated, the outlet opening/closing device 550 may be formed as a bar type with a predetermined thickness along its length and configured to be inserted into the slide groove 150 for reciprocating movement along the axial direction. Here, an opening hole 551 is formed on the outlet opening/closing device 550, configured to be positioned over the oil flow path 110 during axial inward movement to open the oil flow path 110, and to move outside the oil flow path 110 during axial outward movement, allowing the oil flow path 110 to be blocked by the outlet opening/closing device 550. The axial outer end 555 of the outlet opening/closing device 550 is configured to protrude outside the housing 100 when blocking the oil flow path 110, and during oil filter 300 installation, it contacts and is pressed by the opening/closing device pressing portion 350, moving the outlet opening/closing device 550 inward axially to open the oil flow path 110.

Furthermore, an elastic member 552, for example a compression spring, is provided between the axial inner end of the outlet opening/closing device 550 and the axial inner end of the slide groove 150, compressing during axial inward movement of the outlet opening/closing device 550, and upon release of the pressure from the opening/closing device pressing portion 350 due to oil filter 300 removal, transmitting tensile elastic force to the outlet opening/closing device 550 to move it outward axially, thereby blocking the oil flow path 110.

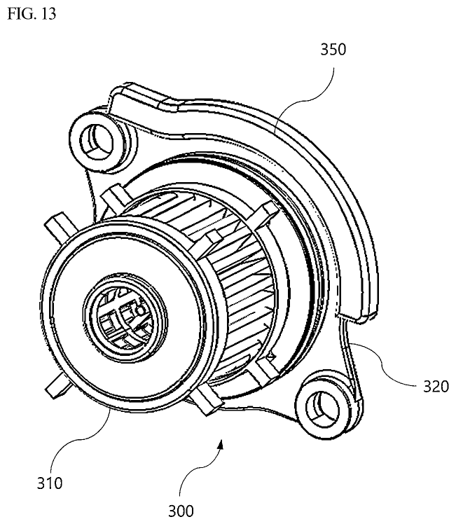

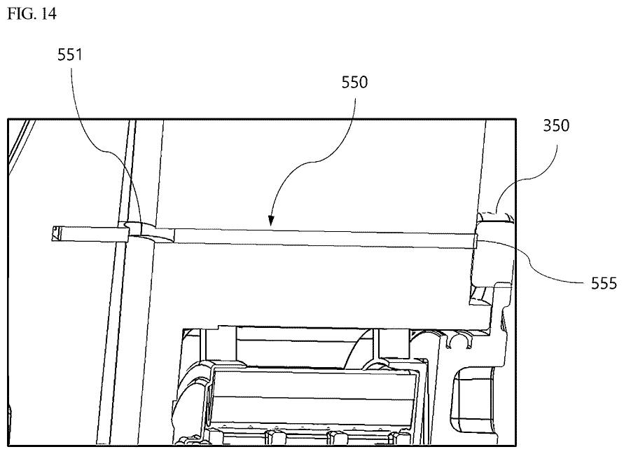

FIG. 13 is a perspective view illustrating an oil filter 300 according to an embodiment of the present disclosure, and FIG. 14 is an enlarged cross-sectional perspective view illustrating the drive mechanism of the outlet opening/closing device 550 and the oil filter 300 according to an embodiment of the present disclosure.

As illustrated, the oil filter 300 includes a cylindrical filter body 310 and a filter cap 320 provided at the outer end of the filter body 310 to seal the open side of the filter housing 200 and fix the filter body 310 to the filter housing 200. Here, an opening/closing device pressing portion 350 may be formed on the radially outer side of the filter cap 320. The pressing portion 350 is formed with a certain length along the circumferential direction and has a predetermined thickness inward in the axial direction.

Thus, as shown in FIG. 14, when the oil filter 300 moves inward in the axial direction for installation, the axial inner surface of the pressing portion 350 contacts the axial outer end 555 of the outlet opening/closing device 550, pressing the protruding end 555 inward axially to move the outlet opening/closing device 550 inward.

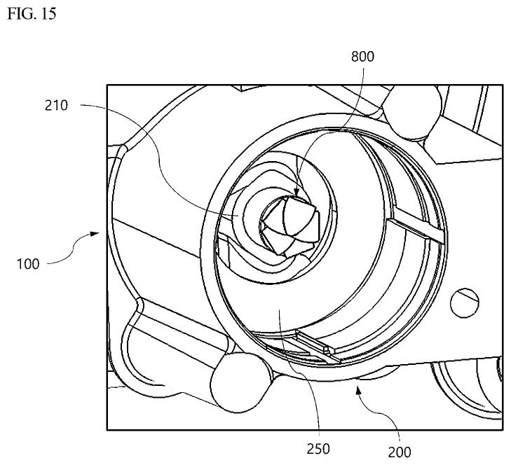

FIG. 15 is a cross-sectional perspective view illustrating an oil filter housing 200 including an outlet opening/closing device 800 according to a third embodiment of the present disclosure.

As illustrated, the filter housing 200 is cylindrical with a filter insertion space 250 formed inside, with an inner end sealed by the housing 100 and an outer end open. At the inner end of the filter housing 200, an oil discharge pipe 210 may protrude outward in the axial direction at the center, and the oil discharge pipe 210 is connected to the inlet side of the oil flow path 110, as described above, to supply oil from the filter hollow portion filtered through the oil filter 300 to the oil flow path 110.

At this time, the outlet opening/closing device 800 is provided at the inlet side end of the oil discharge pipe 210 to open or close the inlet side end of the oil discharge pipe 210. The outlet opening/closing device 800 is made of rubber material, sealing the oil discharge pipe 210 under normal conditions, and may have a rubber seal structure that opens upon pressurization.

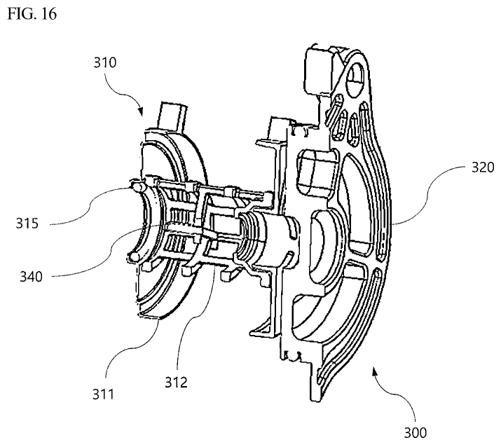

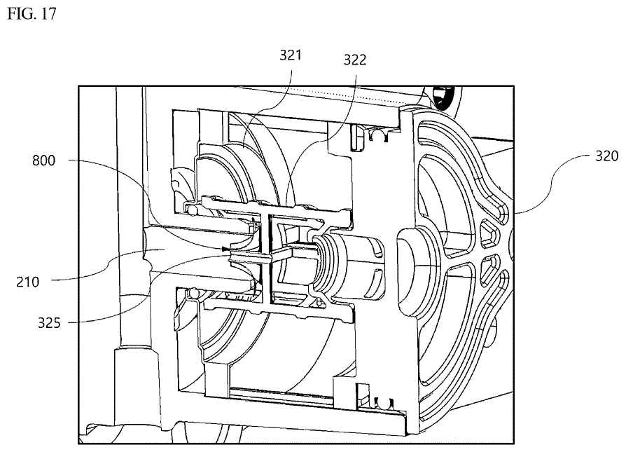

FIG. 16 is a cross-sectional perspective view illustrating an oil filter 300 according to a third embodiment of the present disclosure, and FIG. 17 is a cross-sectional perspective view illustrating the opening/closing mechanism of the outlet opening/closing device 800 due to the coupling of the filter housing 200 and the oil filter 300 according to the third embodiment of the present disclosure.

As illustrated, the oil filter 300 has the following configuration to press and open the outlet opening/closing device 800.

The oil filter 300 includes a cylindrical filter body 310 and a filter cap 320 provided at the outer end of the filter body 310 to seal the open side of the filter housing 200 and fix the filter body 310 to the filter housing 200. The filter body 310 includes an upper cover 311 formed on the axial inner side and a connection frame 312 for connecting the upper cover 311 and the filter cap 320. A hollow portion 315 through which the oil discharge pipe 210 passes may be formed on the upper cover 311. At this time, a pressing protrusion 340 may be formed on the connection frame 312 to press and open the outlet opening/closing device 800 when the oil filter 300 is installed and the oil discharge pipe 210 is inserted into the hollow portion 315 of the upper cover 311. The pressing protrusion 340 is disposed at the axial center of the connection frame 312, formed along the axial direction, and its axial outer end may be fixed on the connection frame 312.

Thus, as shown in FIG. 17, when the oil filter 300 moves inward in the axial direction for installation, the pressing protrusion 340 presses the outlet opening/closing device 800 to open it; when the oil filter 300 moves outward in the axial direction for removal, the pressing protrusion 340 disengages from the outlet opening/closing device 800, allowing the outlet opening/closing device 800 to seal the oil discharge pipe 210 due to elasticity.

The oil-cooled drive motor including an oil filter according to the present disclosure, with the above configuration, is advantageous for preventing oil leakage from the oil flow path into the oil filter insertion space by blocking the oil inlet and oil flow path during oil filter replacement.

Additionally, the oil-cooled drive motor including an oil filter according to the present disclosure is advantageous for preventing oil waste, simplifying the filter replacement process, and reducing working time by eliminating the need to fully drain leaked oil before replacing the filter and refilling the oil afterward.

Furthermore, the oil-cooled drive motor including an oil filter according to the present disclosure is advantageous for further simplifying the filter replacement process and reducing working time by allowing the oil flow path to open or close in conjunction with the rotation of the oil filter during replacement, without requiring a separate process or device.

The technical concept of the present disclosure should not be construed as being limited to the above embodiments. The scope of application varies, and various modifications can be made at the level of those skilled in the art without departing from the gist of the disclosure claimed in the claims. Thus, such improvements and modifications fall within the protection scope of the present disclosure as long as they are obvious to those skilled in the art.

What is claimed is:

1. An oil-cooled drive motor comprising:
a housing accommodating components therein, including an oil flow path through which refrigerant flows to cool the components;
a filter housing disposed on the housing; and
a replaceable oil filter coupled replaceably with the filter housing for filtering foreign substances in the refrigerant,
wherein the filter housing comprises:
a filter insertion space configured to fixedly accommodate the oil filter;
an oil inlet configured to communicate the filter insertion space with a discharge side of the oil flow path to supply oil to the filter insertion space;
an oil discharge pipe configured to communicate with an inlet side of the oil flow path to return oil filtered through the oil filter to the oil flow path, protruding toward the filter insertion space; and
an opening/closing door provided on an inner surface of the filter insertion space, configured to seal the oil inlet by moving to one side in a circumferential direction and open the oil inlet by moving to the other side in the circumferential direction.

2. The oil-cooled drive motor according to claim 1, wherein the replaceable oil filter is configured to be inserted into the filter insertion space along an axial direction and then constrained or released by rotation, and comprises a cylindrical filter body configured to filter oil supplied to the filter insertion space while the oil moves radially inward to a hollow portion of the filter body, the filter body comprising a first-first driving protrusion formed on one side in the circumferential direction and a first-second driving protrusion spaced on the other side, both formed around an axial outer circumference of the filter body and protruding radially outward, and, upon insertion of the replaceable oil filter into the filter insertion space, the first-first driving protrusion and the first-second driving protrusion being configured to fit circumferential ends of the opening/closing door therebetween, causing the opening/closing door to reciprocate in the circumferential direction in conjunction with the rotation of the replaceable oil filter during constraint or release.

3. The oil-cooled drive motor of claim 2, wherein the opening/closing door is configured to open the oil inlet upon constraint of the replaceable oil filter and seal the oil inlet upon release of the replaceable oil filter,
wherein the replaceable oil filter is constrained in the filter insertion space by rotation to one side in the circumferential direction and released from the filter insertion space by rotation to the other side in the circumferential direction.

4. The oil-cooled drive motor of claim 2, wherein the inner surface of the filter insertion space comprises:
a first rail groove recessed radially outward along the circumferential direction, configured to guide the circumferential movement of the first-first and first-second driving protrusions; and
a second rail groove recessed radially outward along the axial direction, configured to guide the axial movement of the first-first and first-second driving protrusions.

5. The oil-cooled drive motor of claim 4, wherein the opening/closing door is formed as a plate with an arc-shaped cross-section configured to slide along the inner surface of the filter insertion space, and comprises a first rail protrusion on the outer circumferential surface of the opening/closing door, formed along the circumferential direction and protruding radially outward to be inserted into the first rail groove.

6. The oil-cooled drive motor of claim 4, wherein the first-first and first-second driving protrusions are formed on the axial outer side of the filter body, and a second-first and second-second driving protrusion are formed at a certain distance inward in the axial direction from the first-first and first-second driving protrusions of the filter body.

7. The oil-cooled drive motor of claim 2, wherein the filter insertion space comprises a stopper protruding radially inward, configured to abut a circumferential end on one side of the opening/closing door to prevent further movement in one circumferential direction upon the opening/closing door sealing the oil inlet.

8. The oil-cooled drive motor of claim 1, wherein the drive motor further comprises an outlet opening/closing device configured to open or block an upstream side of the oil flow path through which oil discharged from the replaceable oil filter flows.

9. The oil-cooled drive motor of claim 8, wherein the housing comprises a movable slide groove formed orthogonal to the oil flow path and configured to allow the outlet opening/closing device to be inserted and moved therein, the outlet opening/closing device being configured to open the oil flow path by sliding to one side and block the oil flow path by sliding to the other side.

10. The oil-cooled drive motor of claim 9, wherein the slide groove is formed adjacent to the filter housing, with an elastic member provided between one end of the outlet opening/closing device and one end of the slide groove, the outlet opening/closing device being configured to be pressed by the replaceable oil filter during axial inward movement to open the oil flow path by sliding inward, and to slide to the other side in the axial direction by the elasticity of the elastic member during axial outward movement of the replaceable oil filter to close the oil flow path.

11. The oil-cooled drive motor of claim 1, further comprising an outlet opening/closing device configured to open or close the inlet side of the oil discharge pipe.

12. The oil-cooled drive motor of claim 11, further comprising an outlet opening/closing device provided at an end of the oil discharge pipe, configured to open or close the oil discharge pipe, the outlet opening/closing device comprising a rubber sealing portion configured to close the oil discharge pipe under normal conditions and open upon pressurization, and the replaceable oil filter further comprising a pressing protrusion configured to press the outlet opening/closing device during axial inward movement for installation and release the pressure on the outlet opening/closing device during axial outward movement for removal.
